(19) United States
(12) Patent Application Publication
(10) Pub. No.: US 2026/0187164 A1
(43) Pub. Date: Jul. 2, 2026

(54) GENERATIVE ARTIFICIAL INTELLIGENCE

(71) Applicant: Google LLC, Mountain View, CA (US)

(72) Inventors: Sugato Basu, Redwood City, CA (US); Shashank Bhushan, Sunnyvale, CA (US); Somil Gupta, Mountain View, CA (US); Alpa Jain, Los Altos, CA (US); Shahab Kamali, Portola Valley, CA (US); Yu Liu, Cupertino, CA (US); Max Moroz, Sunnyvale, CA (US); Lan Nie, Fremont, CA (US); Aidan Davis Oldershaw, San Francisco, CA (US)

(21) Appl. No.: 18/859,311

(22) PCT Filed: May 22, 2024
(86) PCT No.: PCT/US2024/030485

§ 371 Date: Oct. 23, 2024

Related U.S. Application Data
(60) Provisional application No. 63/503,685, filed on May 22, 2023.

(51) Int. Cl. G06F 16/9532; G06F 16/954

(52) U.S. Cl. CPC G06F 16/9532; G06F 16/954

(57) ABSTRACT

Methods, systems, and apparatus, including computer programs encoded on a computer storage medium, for generating digital components. A prompt that includes a query and a set of constraints that limit clauses generated by a language model is generated. The set of constraints includes a summary of a specified source of online content. Multiple candidate digital components are generated using clauses generated by the language model using the summary of the specified source of online content. One or more post-processing operations that evaluate one or more characteristics of the multiple candidate digital components are performed. Each of the multiple candidate digital components are ranked based on the post-processing operations. At least one output digital component that is in a set of highest ranked candidate digital components is served.

### CROSS-REFERENCE TO RELATED APPLICATIONS

This application claims priority to U.S. Provisional Application No. 63/503,685, filed on May 22, 2023. The disclosure of the prior application is considered part of and is incorporated by reference in the disclosure of this application.

### BACKGROUND

This specification relates to data processing and generative artificial intelligence.

Advances in machine learning are enabling artificial intelligence to be implemented in more applications. For example, large language models have been implemented to allow for a conversational interaction with computers using natural language rather than a restricted set of prompts. This allows for a more natural interaction with the computer.

### SUMMARY

In general, one innovative aspect of the subject matter described in this specification can be embodied in methods that include the actions of generating, by an artificial intelligence system, a prompt that includes a query and a set of constraints that limit clauses generated by a language model, wherein the set of constraints includes a summary of a specified source of online content; generating, by the artificial intelligence system, multiple candidate digital components using clauses generated by the language model using the summary of the specified source of online content; performing, by the artificial intelligence system, one or more post-processing operations that evaluate one or more characteristics of the multiple candidate digital components; ranking, by the artificial intelligence system, each of the multiple candidate digital components based on the post-processing operations; and serving, by the artificial intelligence system, at least one output digital component that is in a set of highest ranked candidate digital components.

These and other embodiments can each optionally include one or more of the following features. Methods can include collecting passages from a set of online resources using a site-constrained query that requires the passages be collected from one or more network locations specified in a site-constraint; and summarizing the passages collected from the one or more network locations into a passage summary.

Generating the prompt can include inserting at least a portion of the passage summary into the prompt as a contextual constraint that limits content created by the language model to subject matter specified in the contextual constraint.

Generating the prompt can include inserting an entity name of an entity referenced by the one or more network locations into the prompt as an entity constraint specifying that content identifying the entity must be included in content created by the language model.

Generating the prompt can include inserting, into the prompt, a grounding constraint that requires content created by the language model to be present in a specified set of online resources.

Inserting a grounding constraint into the prompt can include inserting a second level domain into the prompt that requires content created by the language model to be present in resources within the second level domain.

Generating the multiple candidate digital components can include combining an output of the language model with a link to the second level domain.

Performing one or more post-processing operations that evaluate one or more characteristics of the multiple candidate digital components can include generating, for each clause of an output of the language model, a grounding score specifying a likelihood that the clause is factual; filtering the output of the language model by removing one or more clauses having a grounding score that fails to meet a grounding threshold that delineates between clauses that are classified as factual and not factual; and replacing the one or more removed clauses with another clause of the output having a grounding score that meets the grounding threshold.

Performing one or more post-processing operations that evaluate one or more characteristics of the multiple candidate digital components can include for each given candidate digital component among the multiple candidate digital components: evaluating a relevance of the clauses in the given candidate digital component to the query of the prompt; evaluating a level of completeness of the clauses specifying how comprehensively the clauses in the given candidate digital component describe topics in a second level domain that is linked to by the given candidate digital component; and evaluating a tone of the clauses of the candidate digital component to determine whether the clauses characterize an item as positive or negative.

The details of one or more embodiments of the subject matter described in this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a block diagram of an example environment in which generative artificial intelligence can be implemented.

FIG. 2 is a block diagram illustrating interactions between an artificial intelligence system, a language model, and a client device.

FIG. 3 is a flow chart of an example process of artificial intelligence generating creative and factual digital components.

FIG. 4 a block diagram of an example computer.

Like reference numbers and designations in the various drawings indicate like elements.

### DETAILED DESCRIPTION

This specification describes techniques for enabling artificial intelligence to generate new digital components that are creative and factual. Artificial intelligence (AI) is a segment of computer science that focuses on the creation of intelligent agents that can learn and act autonomously (e.g., without human intervention). Artificial intelligence systems can utilize one or more of (i) machine learning, which focuses on developing algorithms that can learn from data, (ii) natural language processing, which focuses on understanding and generating human language, and/or (iii) computer vision, which is a field that focuses on understanding and interpreting images and videos. Artificial intelligence systems can include generative models that generate new content (e.g., images/video, text, audio, or other content) in response to input prompts.

The techniques described throughout this specification enable artificial intelligence to generate large numbers of new digital components using various combinations of text and/or images that are not only creative, but are also factual. For example, an artificial intelligence system can gather information from various sources, such as various web pages or other trusted online resources, and combine this information in different ways to create different candidate digital components. Generally, speaking, the system utilizes an input prompt to a language model, such as a large language model (LLM), that outputs multiple clauses. The system uses the clauses to create multiple different digital components, and then performs post-processing to select, from among the different candidate digital components, the output digital component.

As discussed in more detail below, the prompt is specialized (e.g., created or augmented) to improve the overall quality of the candidate digital components generated. Post-processing operations are then used to evaluate the generated candidate digital components against each other to determine which candidate digital components have higher quality than other candidate digital components (e.g., given the current context), and one or more of the higher quality digital components are output to a computing device (e.g., user computer, mobile device, tablet device, audio device, gaming device, etc.).

Using the specialized prompt reduces wasted computing resources that would otherwise generate more low-quality digital components if a more general prompt were used. Similarly, as discussed in more detail below, the number of candidate digital components generated can be reduced, thereby saving computing resources and generating an output faster, by using the specialized prompt to constrain the parameters used by the language model to generate the candidate digital components. For example, by constructing the prompt to limit the type of content that can be included in generated candidate digital components, the language model will not generate candidate digital components that violate the constraints in the prompt, thereby avoiding the creation of unwanted candidate digital components, which reduces the time required to generate the candidate digital components, the memory required to store the candidate digital components, and the computing resources required to generate and evaluate the candidate digital components. This all contributes to a system capable of creating new digital components faster, such that they can be created and served in a real time interactive environment—e.g., in response to a user search query.

The post-processing operations can include, for example, evaluating the candidate digital components based on various criteria, and scoring each of the candidate digital components based on the evaluation. For example, one post-processing operation can perform a prediction regarding the likelihood that a particular candidate digital component is ungrounded (e.g., includes information that cannot be verified in a specified corpus). Using this type of a post-processing operation allows for looser constraints in the construction of the specialized prompt, which can allow the language model to generate more creative candidate digital components, while still ensuring that the output digital component has at least a baseline level of truthfulness. The post-processing operations can also use various heuristics to evaluate different characteristics of each of the candidate digital components, and the scores can be assigned based on the various heuristics. In some implementations, the scores are weighted and aggregated to create a final score, which is used to rank the candidate digital components. Additionally, or alternatively, a machine learning model can be trained to score digital component quality, and those scores can be used to rank the candidate digital components. One or more of the highest-ranking candidate digital components are then selected for serving as output digital components.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

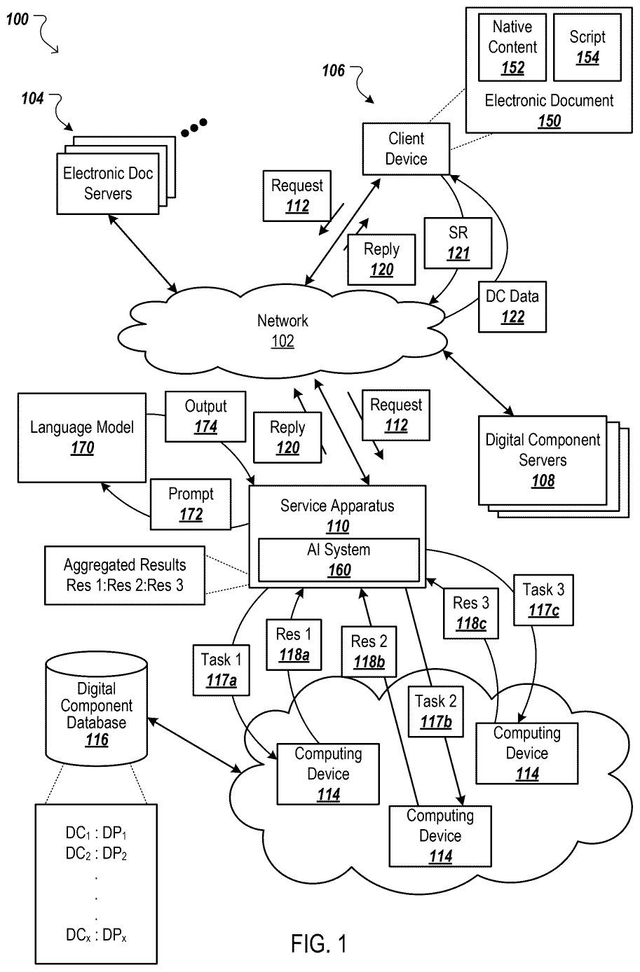

FIG. 1 is a block diagram of an example environment 100 in which generative artificial intelligence can be implemented. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence system 160 configured to autonomously generate digital components, either prior to a request 112 (e.g., offline) and/or in response to a request 112 (e.g., online or real-time). As described in more detail throughout this specification, the artificial intelligence (“AI”) system 160 can collect online content about a specific entity (e.g., digital component provider or another entity) and summarize the collected online content using one or more language models 170, which can include large language models.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution (e.g., a probability distribution) that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CORR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In some implementations, the AI system 160 can generate a prompt 172 that is submitted to the language model 170, and causes the language model 170 to generate the output sequences 174, also referred to as passages or simply as “output”. The AI system 160 can generate the prompt in a manner (e.g., having a structure) that identifies a list of online sources of information, such as a list of websites or data repositories, and specifying a set of constraints the language model 160 must use to generate a summary of information found at the online sources specified in the prompt 172. To initiate creation of the output sequences 174, the AI system 160 submits the prompt 172 to the one or more language models 170, which use the prompt 172 to evaluate the information found at the online sources specified in the prompt 172, and generate the output 174 that summarizes the information according to the constraints specified in the prompt 172.

The AI system 160 can use the generated summary as part of another prompt 172 that is sent to the language model 170. For example, the AI system 160 can insert the generated summary into an additional prompt 172 (e.g., a prompt generated after receiving the summary) that is submitted to the language model 170 as a constraint for generating clauses for use in digital components being generated by the AI system 160. More specifically, assume that the AI system 160 is generating a digital component to provide in response to the request 112, which includes a keyword/query. In this example, the AI system 160 can generate the additional prompt 172 to include the query and a set of constraints including the summary received in the prior output 174. The set of constraints of the additional prompt 172 can also include instructions regarding how clauses generated by the language model 170 using the additional prompt 172 are to be formatted, styled, semantically styled, among other things (e.g., specifying content that should be excluded from the clauses, such as granular details, such as numbers). For example, the additional prompt 172 could take the following form:
Write a good_output—a search digital component where the query is “10g network” and entity is “example_network_provider”. good_output is based only on the key parts of this summary: “200 Mbps internet with WiFi equipment on the example_network_provider 10G Network—$ 50/mo for 2 years. example_network_provider 10G Network is getting faster and more reliable every day. example_network_provider gives you all this and then some. example_network_provider Mobile is the fastest mobile service and the best price for 2 lines of Unlimited. Stream the latest season wherever you go. Storm-Ready WiFi that's backed by a wireless connection, unlimited data, and a battery.” good_output must be in bullet-point format. good_output must have exactly 3 bullet-points. Each bullet-point must be less than 90 characters. good_output must have no nested bullets. good_output must be catchy and show value-prop. good_output must be useful and informative, and must avoid boring details like numbers.

In this example prompt, the AI system 160 is providing the language model 170 with the following constraints:
A query constraint specifies the query “10G Network” to which the output clauses should be relevant.
A entity constraint specifies “example_network_provider” as the entity name to use in the output clauses.
A summary constraint specifies the content summary to use during clause generation, i.e., “200 Mbps internet with WiFi . . . ” .
Styling constraints of “must be in bullet-point format . . . must have exactly 3 bullet-points. Each bullet-point must be less than 90 characters . . . must have no nested bullets” specify the format the output clauses must use.
Semantic/Tone Control constraints of “must be catchy and show value-prop. good_output must be useful and informative, and must avoid boring details like numbers” defines the tone and content of the output clauses generated using the prompt.

Submission of this additional prompt 172 to the language model 170 causes the language model to generate an additional output 174, which includes multiple sets of clauses generated according to the query and constraints, which is communicated electronically to the AI system 160. The AI system 160 receives the clauses of the additional output 174, and generates multiple candidate digital components that could be provided in response to the request 112. In some implementations, each different candidate digital component includes a different combination of the clauses received from the language model 170 in the additional output 174. For example, assume that the additional output 174 includes 12 different clauses, and that the formatting of the digital components being generated by the AI system 160 each include space for three different clauses, the AI system 160 could make 220 different candidate digital components using 3 different clauses in each of the candidate digital components (e.g., 12!/(3!(12−3)!)=220). In some situations, the AI system 160 could also create the candidate digital components using a set of different links to online content (e.g., second level domain links to web pages discussing a topic of the candidate digital components, phone numbers, etc., which can continue to exponentially increase the number of different candidate digital components that the AI system 160 can create using the clauses of the additional output 174 of the language model 170.

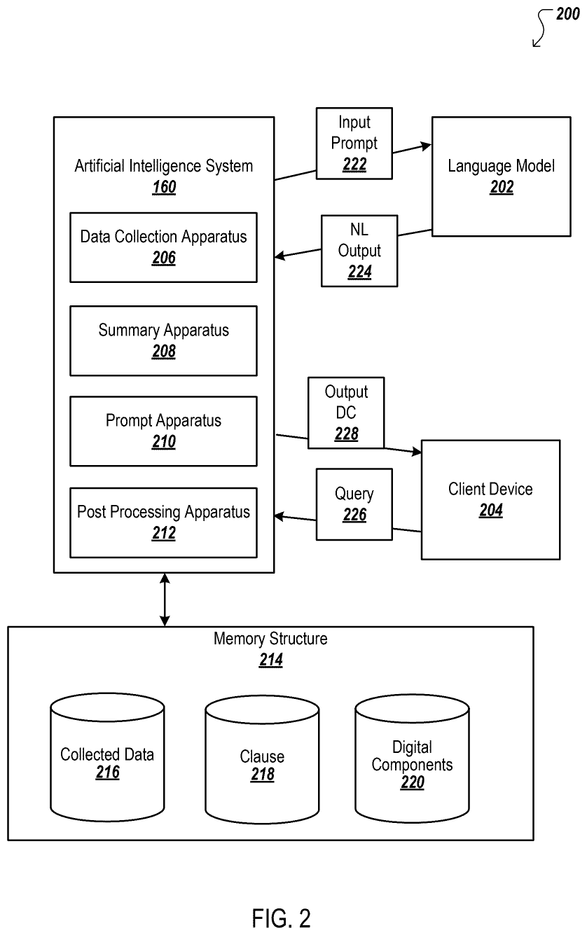

The AI system 160 can perform one or more post-processing operations that evaluate one or more characteristics of the multiple candidate digital components. In some implementations, the post-processing operations can include generating a grounding score for each clause from the additional output 174. The grounding score is a value specifying a likelihood that the clause is factual. The generation of the grounding score is discussed in more detail with reference to FIG. 2.

The post-processing operations can also include an evaluation of the relevance of the clauses to the query constraint, a level of completeness of the clauses relative to content located at the link included in the candidate digital component, and/or an evaluation of the tone (e.g., positive or negative) of the clause. As discussed in more detail with reference to FIG. 2, the post-processing operations can be used to score, or otherwise assign a level of priority to, each of the candidate digital components so that the AI system 160 can rank the multiple candidate digital components relative to each other, and ultimately serve one or more of the highest ranking candidate digital components as output digital components as a reply 120 to the request 112. Note that, although the operations of the AI system 160 and language model 170 are described above as being performed responsive to receipt of the request 112, at least some of the operations can be performed prior to receipt of the request 112, as described in more detail below with reference to FIG. 2.

Furthermore, although a single language model 170 is shown in FIG. 1, different language models can be specially trained to process different prompts at different stages of the processing pipeline. For example, a more general (e.g., larger) language model can be used to generate the summaries of online content as an offline process (e.g., independent of receipt of the request 112), which can then be inserted into prompts that are input to a more specialized and faster language model in an online process (e.g., real-time in response to receiving the request 112. Additionally, the AI system 160 can generate a set of candidate digital components as an offline process (e.g., prior to receiving the request 112, and store the set of candidate digital components in a database. In this scenario, when the AI system 160 receives the request 112, the AI system 160 can further evaluate and rank the stored candidate digital components based on additional information included in the request and other contextual data (e.g., time of day, day of week, weather conditions, etc.).

FIG. 2 is a block diagram 200 illustrating interactions between an artificial intelligence system 160, a language model 202, and a client device 204. In some situations, the language model 202 and client device 204 can, respectively, be the same or similar to the language model 170 and client device 106 of FIG. 1. Although a single language model 202 is depicted in FIG. 2, the language model 202 can be a set of different language models that can be invoked for different tasks for which the different language models are specially trained. For example, one language model within the set of language models may be specially trained to perform content summary tasks, while another model may be specially trained to generate a highly factual output, for example, using the summary output of the specially trained summary language model.

Furthermore, the set of models can include a generalized language model that is larger is size, and capable of generating large amounts of diverse datasets, but this generalized model may have higher latency than the specialized models, which can make it less desirable for use in real-time operations, depending on time latency constraints required to generate content.

The artificial intelligence system 160 includes a data collection apparatus 206, a summary apparatus 208, a prompt apparatus 210, and a post processing apparatus 212. The following description refers to these different apparatuses as being implemented independently and each configured to perform a set of operations, but any of these apparatuses could be combined to perform the operations discussed below.

The artificial intelligence system 160 is in communication with a memory structure 214. The memory structure 214, can include one or more databases. As shown, the memory structure includes a collected data database 216, a clause database 218, and a digital components database 220. Each of these databases 216, 218, and 220, can be implemented in a same hardware memory device, separate hardware memory devices, and/or implemented in a distributed cloud computing environment.

The data collection apparatus 206 is implemented using at least one computing device (e.g., one or more processors), and can include one or more language models. The data collection apparatus 206 is configured to collect information from online data sources. In some implementations, the collected information includes passages that are collected from a set of online resources. To obtain the passages, the data collection apparatus 206 can issue/submit a query to a search system that responds to the query with information about a topic and/or an entity. In some implementations, the collected data obtained by the data collection apparatus 206 can include search result snippets that are returned by the search system in response to submission of the query to the data collection apparatus 206.

In some implementations, the data collection apparatus 206 can be configured to rewrite/augment the query, e.g., using the language model 202 or an internal language model and submitting the rewritten query to the search system. Performing this extra query rewrite and search process increases the diversity of the information collected, which is later summarized, and ultimately used to generate the clauses that will be used to create the candidate digital components. Increasing the diversity of information collected, and ultimately used to generate the clauses can increase the creative character of the candidate digital components by providing more output options for the language models, while still complying with specified constraints.

When an entity (e.g., a company) has an online presence, e.g., website, that provides information about the entity, the query submitted by the data collection apparatus 206 can be a site-constrained query that causes the search system to only reply to the site-constrained query with information contained a specified site (e.g., the website of the company). Of course, multiple site constrained queries can be issued for multiple different sites, or multiple different sites can be specified in the site-constrained query that causes the search system to collect information related to the query from multiple different specified sites (e.g., a social networking site, web answers site, entity review site, etc.). The site constraint can be specified, for example, as a second level domain, or a specific page address depending on where the information is to be sourced from.

The data collection apparatus 206 can store the collected data in the collected data database 216. For example, the data collection apparatus 206 can index the collected data to the query used to collect the data and/or an entity characterized by the collected data so that the collected data can be retrieved from the collected data database 216 for additional operations performed by the data collection apparatus 206 and/or any operations performed by the artificial intelligence system 160.

In some implementations, the collected data can be used to train, or specialize the training of, one or more language models. For example, prompts related to the collected data can be submitted to a general language model, and the output of the general language model can be evaluated based on how closely the output of the general language model aligns with the collected data. More specifically, a quality measure can be computed based on the difference (e.g., factual difference) between the output of the general language model and the collected data related to the prompt. The general language model can then be iteratively adjusted to reduce the difference between the output of the general language model and the collected data, which will result in a higher quality measure, resulting in a specialized language model. This specialized language model can then be used to generate outputs related to the collected data (e.g., topics or content categories of subsets of the collected data).

The summary apparatus 208 is implemented using at least one computing device (e.g., a device including one or more processors), and can include one or more language models. The summary apparatus 208 is configured to summarize information about a topic or entity (e.g., person, place, thing, or concept). In some implementations, the summary apparatus 208 is configured to summarize the data collected by the data collection apparatus 206, and potentially stored in the collected data database 216. For example, the summary apparatus 208 can be configured to accept, as input, the collected data, and output a specified length (e.g., 200 words or some other number of words) summary of the contents of the collected data.

The summary can be generated using the language model 202, which can be part of the summary apparatus 208, or in data communication with the summary apparatus 208. In some implementations, the summary apparatus 208 (or the prompt apparatus 210 discussed below) can generate a summary prompt that is submitted to the language model 202 as an input prompt 222. The summary prompt can specify one or more of the following:
a set of sources that should be used to generate the summary;
details about the set of sources the language model should consider when summarizing the content;
factual grounding instructions specifying that the language model should provide citations to the sources used to generate the summary;
summary constraints specifying information that should not be included in the summary (e.g., information that is not directly supported by the set of sources); and
formatting constraints specifying how the output of the language model should be formatted (e.g., as bullet points or in paragraph form, with or without an introduction summary, total length (e.g., number of characters or separate clauses); and
tone constraints specifying a tone of the output (e.g., creative, funny, sad, serious, or from the perspective of a specified entity, such as an artist, engineer, or story writer).

An example summary prompt can take the form of:
“Given a question and a list of sources, write a short summary that cites individual sources and summarizes all of them as comprehensively as possible. Each source is independent and might repeat or contradict content from other sources. The summary should be directly supported by the given sources and cited appropriately with a [$i] notation following a statement that is supported by $i. If a statement is based on multiple sources, all of these sources should be listed in the brackets, for example [$i, $j, $k]. The summary may start with a general statement about the answer space. The summary shouldn't include any information that cannot be supported by the given sources.”

In this example, the notation $i can placeholders for the names of the sources. The bolded “a list of sources” can be replaced with the names of actual sources to be considered, or be a reference to locations of sources in the set of sources to be considered when creating the summary. The set of sources can be network addresses (e.g., universal resource indicators/locators-URIs/URLs) of online data sources (e.g., second level domains of websites, specific addresses of web pages, or network addressees of other data sources). In some implementations, the set of sources can include the collected data database 216, such that the summary can be generated using the data collected and stored by the data collection apparatus 206. The summary apparatus 208 uses the summary prompt to generate a summary that summarizes passages collected form one or more network locations of the set of sources into a passage summary. As noted above the passage summary can be formatted as a set of bullet points or in paragraph form.

The summary is generated by a language model 202, which as noted above, can be part of the summary apparatus 208, or in data communication with the summary apparatus 208. In either case, the summary apparatus 208 inputs the summary prompt into the language model 202 as an input prompt 222. The language model 202 (e.g., an LLM) processes the input prompt 222, and generates a natural language output (“NL Output”) 224 that summarizes the content of the set of sources according to the instructions/constraints specified in the summary prompt.

An example paragraph summary of a set of sources that provide information about an automobile can take the form of:
The 2.5-liter 4-cylinder engine delivers enhanced horsepower and torque distribution to give you seamless acceleration. State-of-the-art all wheel drive technology comes with six available drive modes—eco, normal, tarmac, gravel, snow, mud—so you can drive confidently in almost any condition. Active Blind Spot Assist can help drivers avoid a collision by detecting other vehicles in the surrounding lanes, even when the human eye can't see them.

An example bullet point summary of the same set of sources can take the form of:
The 2.5-liter 4-cylinder engine delivers enhanced horsepower and torque distribution to give you seamless acceleration.
State-of-the-art all wheel drive technology comes with six available drive modes—eco, normal, tarmac, gravel, snow, mud—so you can drive confidently in almost any condition.
Active Blind Spot Assist can help drivers avoid a collision by detecting other vehicles in the surrounding lanes, even when the human eye can't see them.

The summary can be generated in response to receipt of a query 226 from a client device 204 (e.g., in a real-time or online mode), or generated in an offline mode (e.g., independent of receipt of an instance of the query 226 from a client device 204. In the real-time/online mode, the query 226 received from the client device 204 can be passed to the summary apparatus 208 in parallel with other processing being performed on the query, such as obtaining search results or otherwise generating a language model response to the query, so that the summary apparatus 208 can generate the summary while other query processing operations are being performed, thereby reducing the latency associated with providing the client device 204 with the final response to the query 226.

In the offline mode, the summary apparatus 208 can generate summaries for anticipated queries (e.g., high volume queries) that can be stored in the memory structure for use when the query 226 is received from the client device 204. For example, the summary apparatus 208 can identify a set of highest-ranking queries as it relates to query frequency or another to another metric, such as time sensitivity of a response to the query. In this example, the summary apparatus 208 can, for each query, identify a set of sources relevant to the query and/or stored collected data relevant to the query (e.g., collected using the query or a similar query), and perform operations similar to those discussed above to generate a set of summaries (e.g., one or more summaries) for the query. This set of summaries can be stored in the memory structure 214 (e.g., with an index to the query), and when the client device 204 submits the query 226, the summary apparatus 208 (or another apparatus in the AI system 160), can query the memory structure 214 to retrieve one or more of the summaries indexed to the query 226 to facilitate operations performed using the summaries, as discussed in more detail below. Generating summaries in the offline mode can reduce latency associated with responding to the query 226 submitted by the client device 204 because the operations required to generate the summaries will not preclude downstream operations discussed below (e.g., prompt generation), which rely on the summary.

In some implementations, the summary apparatus 208 can perform one or more post-processing operations on the summary output by the language model. The post-processing operations can evaluate the summary based on one or more of its factuality, relevance, comprehensiveness, brevity, tone, and clarity, as described in more detail below with reference to the post-processing apparatus 212. Of course, the post-processing operations of the summary can be performed by the post-processing apparatus 212 itself in some implementations.

The summary is provided to a prompt apparatus 210, which is implemented using at least one computing device (e.g., a device including one or more processors), and can include one or more language models. The prompt apparatus 210 is configured to generate a prompt that includes a query 226, and a set of constraints.

The query 226 can be received, for example, from a client device 204. The query 226 can be input through a search service, a chat interface, a gaming interface, a digital assistant interface, or another interface to a service provided either online, or through a native application installed at the client device. The query 226 can be as simple as a single token, or can be a series of tokens that constitute a multi-token phrase. In this scenario, the query 226 is received by the AI system 160, and can be inserted into the prompt by the prompt apparatus 210. Additionally, or alternatively, the AI system 160 can use the query 226 to search for, or otherwise obtain, information related to the query 226. For example, the AI system 160 can use the query 226 to identify relevant information in the stored collected data database 216, collect data relevant to the query 226 from various online locations, as described above with reference to the data collection apparatus 206, or otherwise use the query 226 to generate or identify information that can provide additional context for creation of the prompt (e.g., collect weather information related to the query, etc.).

The set of constraints can include a passage summary of a specified source of online content, which summarizes passages of information collected from a set of online resources (e.g., as described above with reference to the data collection apparatus 206). For example, the prompt apparatus 210 can insert, into the prompt, one or more of the summaries generated by the summary apparatus 208. In some implementations, the passage summary inserted into the prompt operates as a contextual constraint that limits content created by the language model 202 responsive to the prompt that contains the summary. For example, the summary can limit the content created by the language model to subject matter specified by the summary that is included in the prompt as a contextual constraint, as described in more detail below.

In constructing the prompt, the prompt apparatus 210 can insert a specified entity name into the prompt. The entity name can be pre-specified or derived. In some implementations, the entity name is pre-specified based on an entity (e.g., content distributor) for whom content is being created. For example, assume that a request to generate content has been submitted to the AI system 160 by Example_Entity_1 (“ET1”). In this example, the prompt apparatus 210 can insert “ET1” into the prompt, which will be submitted to the language model 202 as an input prompt 222, to inform the language model 202 of the entity to be referenced in the NL output 224 of the language model 202. For example, similar to the discussion of the example additional prompt 172 of FIG. 1, in the present example, the prompt apparatus 210 could insert the entity name “ET1” as an entity constraint of the input prompt 222 that is submitted to the language model 202. In this example, the entity constraint “ET1” operates as an indication to the language model 202, that the NL output 224 should reference “ET1”. In some implementations, the prompt apparatus 210 can insert, into the prompt, specific instructions that the NL output 224 generated by the language model 202 must include the entity name inserted into the prompt.

In some implementations, the entity name can be derived. For example, the prompt apparatus 210 (or another apparatus in the AI system 160), can evaluate various data to determine the appropriate entity to specify in an entity constraint inserted into the prompt. The data evaluated can include, for example, sources of data specified in the summary prompt, the summary itself, collected data stored in the collected data database 216, or other sources of information. To illustrate, assume that the sources used to generate the summary refer to ET1 more often than any other entity. In this example, the prompt apparatus 210 can determine, based on the fact that ET1 is referred to more often than any other entity, that ET1 should be expressly mentioned by the NL Output 224 of the language model. In this example, the prompt apparatus 210 has derived the identity of the entity to be referenced in the entity constraint of the prompt by analyzing the sources of information from which the summary was created, rather than being expressly instructed to include a specific entity name in the prompt. This derived entity name can be inserted into the prompt, which will instruct/cause the language model 202 to reference the entity (e.g., textually specify the entity name) in the NL output 224.

The prompt apparatus 210 can be configured to insert one or more grounding constraints into the prompt. A grounding constraint instructs/causes the language model to generate output from a verifiable source (e.g., a set of accessible sources). The inclusion of a grounding constraint in the input prompt 222 can require that content created by the language model 202 be present in a specified set of online resources, or other data sources. To utilize a grounding constraint, the prompt apparatus 210 can insert, into the prompt, an instruction that the NL output 224 of the language model 202 only include information from the summary (e.g., information from the summary that has a corresponding citation), and/or is actually/currently present in a citation referenced in the summary.

Including this grounding constraint causes the language model 202 to construct an NL output 224 that is verifiable within the specified data source (e.g., summary, website, or other data source). This can lead to a more factual and/or accurate NL output 224, which is less prone to “hallucinations,” thereby improving the operation, accuracy, and/or precision of the language model 160, and the AI system 160 as a whole. A language model hallucination refers to a situation in which a large language model (LLM) generates text that is not supported by source data, factually erroneous, or non-sensical (e.g., stating that a dog has antlers). The nature of language models allows them to generate inaccurate, imprecise, or non-sensical outputs absent constraints. However, by using the grounding constraints discussed herein, these types of erroneous or non-sensical outputs can be avoiding, thereby making the outputs of the language model more accurate, precise, and reliable. Furthermore, generating erroneous or non-sensical data wastes computing resources, network bandwidth, mobile client battery power, etc. Reducing the likelihood or occurrence of hallucinations (e.g., using grounding constraints) improves the operation of language models and the systems that rely on outputs of language models, for example, by reducing the distribution of non-factual information, reducing the number of network calls made to/from the language model to arrive at an appropriate answer, and using less computing power generating erroneous information. Reducing the likelihood/occurrence of model hallucinations also results in more efficient use of mobile device battery consumption because the mobile device does not waste processing power or battery consumption processing and displaying hallucinations, which can also lead to more queries by the user, and more responses to be processed and displayed by the client device before arriving at a factual response.

In some implementations, the grounding constraint can specify a particular network location (e.g., second level domain, such as example.com or a full-page address e.g., example.com/example_page) or set of network locations. In these implementations, the prompt apparatus 210 can insert the particular network location or set of network locations into the prompt, which is provided to the language model as the input prompt 222. The inclusion of these network locations into the prompt can instruct/cause the language model 202 to generate content that is present in one or more of the specified network locations, thereby improving the likelihood that the NL output 224 generated by the language model is factually accurate.

The prompt apparatus 210 (or another component of the AI System 160) transmits, conveys, communicates, or otherwise submits the constructed prompt to the language model 202. The language model 202 uses the summary, query, and any of the specified constraints to generate the NL output 224. The NL output 224 can be a set of clauses formatted according to formatting constraints specified in the input prompt 222. For example, if the input prompt 222 includes a formatting constraint specifying “bullet point list”, the NL output 224 can have the form of a bullet list of clauses. The number of clauses included in the NL output 224 can also be specified by a constraint included in the prompt.

In some implementations, the number of clauses generated by the language model 202, and included in the NL output 224 can be higher than a number of clauses that will be used by the AI system 160 to create each candidate digital component. For example, assume that the AI system 160 is going to create candidate digital components that each include 3 clauses. In this example, the AI system 160 can include, in the prompt, an instruction that causes the language model 202 to generate at least 12 clauses.

By instructing the language model 202 to generate more clauses (e.g., sentences, bullet point phrases, etc.) than required to generate an individual candidate digital component, the AI system 160 will be able to create multiple different digital components, while only having to submit a single input prompt 222, and receive/process a single NL output 224. In this way, the system is made more efficient than a system that requires multiple input prompts 222 and multiple single NL outputs 224 to create multiple candidate digital components. For example, by requesting 12 clauses in a single input prompt 222, the AI system 160 will receive 12 clauses in a single NL output 224, which can be used to create 220 different combinations of three clauses. As such, the single NL output 224 in this example can be used to create a minimum of 220 different candidate digital components, whereas the AI system 160 would only one set of clauses to create a candidate digital component if the NL output 224 that only included three clauses.

The AI system 160 can also use other objects to create additional candidate digital components. For example, the AI system 160 can use formatting options (e.g., font, font color, text emphasis, etc.) to create additional candidate digital components. The AI system 160 can also use multiple different links to create different candidate digital components. For example, the AI system 160 can combine the output of the language model 202 (e.g., a set of clauses) with a link to a second level domain, or a specific sub-page within a second level domain, to create a candidate digital component. When the AI system 160 has access to multiple links that are appropriate for a given set of the clauses received from the language model 202, the AI system 160 can generate multiple different candidate digital components that each include the same given set of clauses, but link to different web pages.

For example, assume that the AI system 160 identifies a link to a home page for a website (e.g., example.com), as well as a product information page (e.g., example.com/product_info), and the clauses of the digital component describe the product found at the product information page. In this example, the AI system 160 can create one candidate digital component that links to the home page, and another candidate digital component that links to the product information page, while using the same clauses in each of the candidate digital components.

The clauses obtained form the language model 202 can be stored in a clause database 218 for further processing by the post processing apparatus 212.

The post-processing apparatus 212 of the AI system 160 is implemented using at least one computing device (e.g., a device including one or more processors), and can include one or more language models. The post-processing apparatus 212 is configured to (e.g., specially programmed with code) perform one or more post-processing operations on candidate digital components. In some implementations, the post-processing operations can occur after the digital components have been constructed (e.g., clauses, links, and/or other objects are combined into a candidate digital component). In some implementations the post-processing operations can be performed prior completing construction of the candidate digital components. For example, one or more of the post-processing operations can be performed on the clauses in the NL output 224 of the language model 202 before they are combined with a link to create a completed candidate digital component. As used throughout this specification, performing post-processing operations on the clauses prior to combination into a completed candidate digital component is considered performance of the post-processing on a candidate digital component unless otherwise stated.

Performance of the post-processing operations includes an evaluation of one or more characteristics of a candidate digital component. The characteristics evaluated can include, for example, factuality of clauses generated by the language model 202, relevance of the clauses to the query or summary included in the prompt, a level of completeness of the clauses, and a tone of the clauses. The post-processing operations can be performed on the clauses individually, multiple clauses in combination, and/or a completed candidate digital component that includes other objects, such as links to online resources.

In some implementations, the post-processing apparatus 212 is configured to generate a grounding score for each clause output by the language model 202. The grounding score indicates a likelihood that the clause is factual. For example, a clause that is present in a current version of a specified online resource or data source can be deemed more factual than a clause that is not present in the current version of a specified online resource or data source. Because the language model generates new textual content using the summary, query and constraints, it is likely that many clauses will not be found verbatim in the specified online resource. As such, the evaluation of factuality can be performed using similarity measures and/or another language model. For example, the clauses can be compared to the raw text of the specified online resource or data source to determine a semantic distance of the clause from the text of the specified online resource. Similarly, another language model can be used to determine a level of similarity between the clauses and the text of the online resources or data sources. The post-processing apparatus 212 can generate the grounding score based on the similarity of the clauses to the text of the specified online resources or data sources, where a higher level of similarity corresponds to a higher likelihood of factuality and higher grounding score, while a lower level of similarity corresponds to a lower level of factuality and lower grounding score.

The post-processing apparatus 202 can be configured to filter the clauses output by the language model 202 based on the grounding scores. For example, the post-processing apparatus 202 can remove one or more clauses from consideration for inclusion into a digital component if the grounding scores for those one or more clauses fail to meet a grounding threshold (e.g., minimum specified grounding score). The grounding threshold can be specified by an administrator or designer of the AI system 160, and can be a grounding score that delineates between clauses that are classified as factual and not factual. Using a score to delineate between factual and non-factual clauses removes subjectivity related to a person's evaluation of factual and non-factual, thereby making it an objective evaluation. When a clause is removed form consideration for inclusion in digital components, the AI system 160 can identify another available clause to consider for inclusion or request another set of clauses from the language model 202. For example, if the clauses were initially ranked based on relevance (e.g., in the NL output 224) a next highest ranked clause could replace the removed clause in creating the candidate digital components. Similarly, if a clause is removed form a completed candidate digital component, another clause can be selected to replace the removed clause.

The post-processing apparatus 212 can be configured to evaluate the relevance of each of the clauses to the query or summary included in the prompt. In some implementations, the relevance of the clauses to the query or summary can be performed by embedding the clauses, query, and/or summary in a multi-dimensional semantic space, and determining the cosine distance between the embeddings. The relevance of the clauses to the query or summary can also be determined by inputting the clauses, query, and/or summary into a machine learning model (e.g., neural network) that has been trained to determine semantic relevance between sets of text. The post-processing apparatus 212 can generate a relevance score for each clause based on the analysis (e.g., with higher scores indicating higher levels of relevance), and rank the clauses based on their relevance.

The post-processing apparatus 212 can be configured to evaluate the level of completeness of each of the clauses. The level of completeness of a clause, or set of clauses, specifies how comprehensively the clause, or set of clauses, describe one or more topics. In some implementations, the level of completeness specifies how comprehensively the clause, or set of clauses, describes topics in a second level domain used to generate the summary. The clauses can be evaluated prior to creating a candidate digital component, and ranked, and/or be evaluated together as a group in a candidate digital component. In some implementations, the evaluation specifies how comprehensively the set of clauses in a candidate digital component describe topics in a second level domain (or at specific page) that is linked to by the given candidate digital component. The level of completeness can be higher when the set of clauses (e.g., 3 clauses) in a candidate digital component more fully describe the topics in the second level domain (e.g., provide more of the details), and be lower when the set of clauses less fully describes the topics. The post-processing apparatus 212 can generate a completeness score for each set of clauses and/or each candidate digital component, and rank the sets of clauses/candidate digital components of the completeness score.

The post-processing apparatus 212 can be configured to evaluate the tone of each of the clauses or a set of clauses. The tone of the clauses is an indication of whether the clauses characterize an item in a positive or negative way. In some implementations, the level of positivity or negativity can be used to generate a tone score, e.g., with positive tone clauses having higher tone scores (e.g., positive scores) than neutral and negative tone clauses, and negative tone clauses having lower tone score (e.g., negative scores) than neutral and positive tone clauses. Neutral tone clauses could be assigned, for example, a score of zero so that they do not contribute positively or negatively to the overall tone of a candidate digital component.

The tone of the clauses can be generated, for example, by submitting the clauses to a language model, and asking the language model whether the tone is positive, neutral, or negative. Additionally, or alternatively, the clauses can be input into a machine learning model that has been trained (e.g., using labeled data) to classify clauses as positive, neutral, or negative in tone. The classifications of the clauses can be used to assign a tone score to each clause, and the overall tone of a candidate digital component can be determined by aggregating (e.g., summing) the tone scores of the individual clauses. The post-processing apparatus 212 can rank the clauses/candidate digital components based on the tone scores.

The post-processing apparatus 212 can be configured to rank candidate digital components based on one or more of the post-processing operations. For example, the post-processing apparatus 212 can rank each of the candidate digital components based on any of the scores/evaluations discussed above, or a combination of the scores/evaluations discussed above. For example, the post-processing apparatus can sum or average multiple different scores to obtain an aggregate score for a clause, set of clauses, or candidate digital component. In some implementations, the scores can be weighted based on a relative importance of each evaluation to obtain the aggregate score (e.g., weighted average). Using the aggregate scores, the post-processing apparatus 212 can rank the clauses, sets of clauses, or candidate digital components, and one or more highest ranking candidate digital components can be identified as one or more output digital components (“Output DC”) 228 that are served to a client device by the AI system 160. In some implementations, the creation and serving of the output digital components 228 are performed after receiving the query 226. In some implementations, the output digital components 228 can be generated in an offline process (e.g., prior to receipt of the query 226), and stored in a digital components database 220 until receipt of the query 226. At that time, one or more of the output digital components 228 can be retrieved from the digital components database 220, and served to the client device 204.

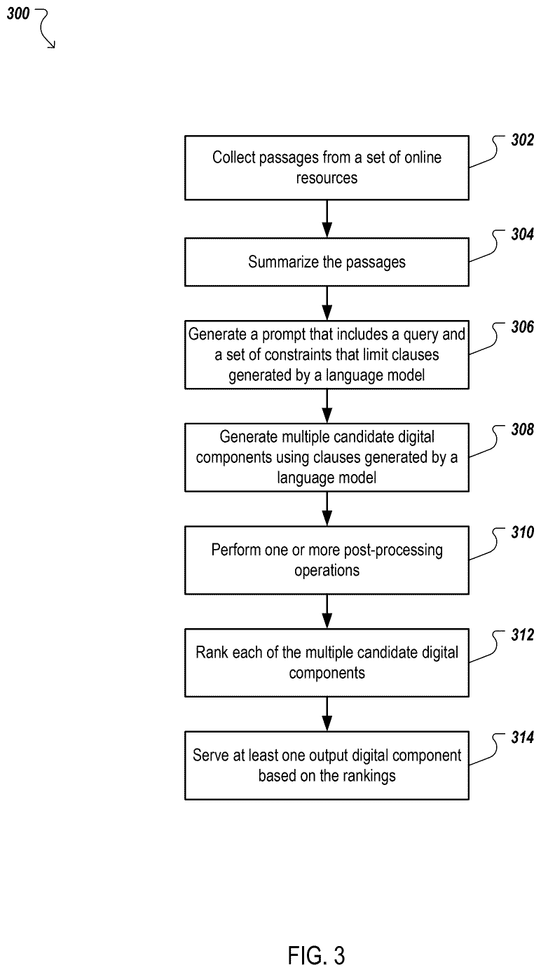

FIG. 3 is a flow chart of an example process 300 for creating and serving digital components with artificial intelligence. Operations of the process 300 can be performed, for example, by the service apparatus 110 of FIG. 1 (e.g., including the AI system 160 and/or language model 170), or another data processing apparatus. The operations of the process 300 can also be implemented as instructions stored on a computer readable medium, which can be non-transitory. Execution of the instructions, by one or more data processing apparatus, cause the one or more data processing apparatus to perform operations of the process 300.

Passages are collected from a set of online resources (302). As discussed above, the passages can be collected in a number of ways. For example, the passages can be collected using a site-constrained query that requires the passages be collected from one or more network locations specified in a site-constraint. In a specific example, the site-constrained query can include a site-constraint (e.g., query parameter) specifying that a content search using the query must be limited to locations within a second level domain (e.g., example.com) specified in the site-constraint, or a specific page within the second level domain (e.g., item detail page).

The passages can be collected in an offline process (e.g., independent of and/or prior to when the query is received from a client device), or in an online process performed when processing the query received from the client device. Additional details of the passage collection are provided above with reference to the data collection apparatus 206.

The collected passages are summarized into a passage summary (304). As discussed above, the summarization of the passages collected from the one or more network locations can be performed by a language model that is trained to summarize multiple passages of text, such as a large language model. In some implementations, the passages are collected from a list of sources specified in a summary prompt that is generated by an artificial intelligence system and submitted to a large language model, as described above.

The summary prompt submitted to the large language model can specify one or more of the following:
a set of sources that should be used to generate the summary;
details about the set of sources the language model should consider when summarizing the content;
factual grounding instructions specifying that the language model should provide citations to the sources used to generate the summary;
summary constraints specifying information that should not be included in the summary (e.g., information that is not directly supported by the set of sources); and
formatting constraints specifying how the output of the language model should be formatted (e.g., as bullet points or in paragraph form, with or without an introduction summary, total length (e.g., number of characters or separate clauses); and
tone constraints specifying a tone of the output (e.g., creative, funny, sad, serious, or from the perspective of a specified entity, such as an artist, engineer, or story writer).

An example summary prompt, and additional details regarding the generation of the summary are provided above with reference to the summary apparatus 208.

A prompt (e.g., additional prompt) that includes a query and a set of constraints that limit clauses generated by a language model is generated/constructed (306). The prompt that includes the query and the set of constraints differs from the summary prompt, and as described above, the set of constraints can include the summary generated using the summary prompt as a summary constraint. For example, generation of the prompt can include inserting at least a portion of the passage summary into the prompt as a contextual constraint that limits content created by the language model to subject matter specified in the contextual constraint.

Additionally, generation of the prompt can include inserting an entity name of an entity referenced by the one or more network locations into the prompt as an entity constraint. The entity constraint specifies that content identifying the entity must be included in content created by the language model. In other words, the entity constraint instructs/causes the language model to include content identifying the entity in content (e.g., clauses) created by the language model.

Generation of the prompt can also include inserting, into the prompt, a grounding constraint that requires content created by the language model to be present in a specified set of online resources. For example, insertion of the grounding constraint into the prompt can be achieved by inserting a second level domain (e.g., example.com) into the prompt that requires content created by the language model to be present in resources within the second level domain. Of course, network locations of other data sources (e.g., databases, such as the collected data database 216, individual web pages, etc.) can be inserted into the prompt as grounding constraints. The generation of the prompt is discussed in more detail above with respect to the prompt apparatus 210.

Multiple candidate digital components are generated/constructed using clauses generated by a language model (308). In some implementations, the clauses are generated using the summary of the specified source of online content. A candidate digital component can be a single clause obtained from the language model, or a combination of clauses obtained from the language model. The candidate digital component can also include other objects/items, such as links to online resources, scripts that enable various user interactions with the digital component (e.g., making reservations, launching a game, launching an augmented reality environment, etc.). For example, one or more of the candidate digital components can be generated by combining an output of the language model (e.g., one or more clauses) with a link to a second level domain (e.g., a home page of example.com) and/or a link to a specific page within the second level domain (e.g., an item information page of an item described by the clauses).

In some implementations, each different candidate digital component includes a different combination of the clauses received from the language model. For example, as discussed above, if the output of the language model (e.g., generated using the prompt from operation 306) includes 12 different clauses, and each of the digital components being generated by the AI system are formatted to include space for three different clauses, the AI system could make 220 different candidate digital components using 3 different clauses in each of the candidate digital components (e.g., 12!/(3!(12−3)!)=220). Of course, adding other sets of objects/items to the digital components would expand the possible number of combinations further.

One or more post-processing operations are performed (310). In some implementations, the one or more post processing operations include operations that evaluate one or more characteristics of each given candidate digital component among the multiple different candidate digital components. As noted above, a candidate digital component can be a single clause output from the language model, a combination of clauses, and/or other objects combined with one or more of the clauses output from the language model. As such, the post-processing operations can be performed on any of these candidate digital components, including individual clauses.

Performance of one or more the post-processing operations can be achieved by evaluating how factual a candidate digital component is. In some implementations, the evaluation of how factual a candidate digital component is can be evaluated based on whether the information within the candidate digital component can be verified at one or more specified data sources.

For example, assume that a digital component is describing an object using multiple clauses generated by a language model. In this example, the information about the object will have been collected from a set of online resources as described above with reference to operation 302, summarized as described above with reference to operation 304, and used by a language model to generate clauses that are output by a language model. The clauses that are output from the language model may differ from the passages collected in operation 302, for example, to present the information from the passages in a more creative manner. As such, the clauses may not be found verbatim in the set of online resources, but the clauses can still be analyzed to determine whether the information being conveyed by the clauses are consistent with information conveyed by the original passages, as described in more detail above with reference to the post-processing apparatus 212.

In some implementations, the evaluation of how factual a candidate digital component (e.g., a single clause or combination of clauses) is, can be performed using grounding scores, as described above with reference to the post-processing apparatus 212. For example, for each clause of an output of the language model, a grounding score specifying a likelihood that the clause is factual can he generated based on a level of similarity/difference between the clause and content of a specified online resource or data source.

Using the grounding scores, one or more clauses can be filtered out (e.g., removed from consideration for serving in a candidate digital component). For example, one or more clauses having a grounding score that fails to meet a grounding threshold can be removed from consideration. The grounding threshold is specified to delineate between clauses that are classified as factual and not factual. Using a specified grounding threshold (e.g., minimum score) that is based on a semantic distance (e.g., cosine distance) between a clause and reference content (e.g., at the specified online resource) removes subjectivity of whether information is factual or non-factual, resulting in an objective classification system. When one or more clauses are removed for failing to meet the grounding threshold, those one or more clauses can be removed and replaced with another clause of the output having a grounding score that meets the grounding threshold, or another clause can be evaluated for inclusion in the set of clauses in consideration for inclusion in digital components.

As discussed above with reference to the post-processing apparatus 212, the post-processing operations can include evaluations of other characteristics of the candidate digital components. For example, each given candidate digital component among the multiple candidate digital components can be evaluated with respect to its relevance, completeness, and tone, among other things. The evaluation of the relevance can include evaluating a relevance of the clauses in the given candidate digital component to one or more of the query of the prompt, the summary of the prompt, search results snippets generated using the query of the prompt, or content of the set of online resources from which the passages were collected (or another specified online data source).

The evaluation of the level of completeness specifies how comprehensively the clauses in the given candidate digital component describe one or more topics. As previously discussed, the one or more topics can be those topics found in a second level domain that is linked to by the given candidate digital component or used to generate the summary. The level of completeness can be higher when the set of clauses (e.g., 3 clauses) in a candidate digital component more fully describe the topics in the second level domain (e.g., provide more of the details found in the second level domain), and be lower when the set of clauses less fully describes the topics. For example, an artificial intelligence agent/machine learning system can compare the semantic space covered (e.g., in a multidimensional semantic space) by the content of the second level domain with the semantic space covered by the set of clauses. The difference between the semantic space covered (e.g., a mathematical difference or ratio) can be used to arrive at a completeness score for the set of clauses. The difference between the semantic space covered by different sets of content can be determined, for example, by embedding the text of the content (e.g., in vector representations), and determining a distance between (or a level of overlap between) the embeddings. Additionally, or alternatively, the different sets of content can be input to a neural network trained to determine semantic similarity.

The post-processing operations can include evaluating a tone of the clauses of the candidate digital component to determine whether the clauses characterize an item in a positive tone or negative tone. In some implementations, the level of positivity or negativity can be used to generate a tone score, e.g., with positive tone clauses having higher tone scores (e.g., positive scores) than neutral and negative tone clauses, and negative tone clauses having lower tone score (e.g., negative scores) than neutral and positive tone clauses. Neutral tone clauses could be assigned, for example, a score of zero so that they do not contribute positively or negatively to the overall tone of a candidate digital component.

The tone of the clauses can be generated, for example, by submitting the clauses to a language model, and asking the language model whether the tone is positive, neutral, or negative. Additionally, or alternatively, the clauses can be input into a machine learning model that has been trained (e.g., using labeled data) to classify clauses as positive, neutral, or negative in tone. The classifications of the clauses can be used to assign a tone score to each clause, and the overall tone of a candidate digital component can be determined by aggregating (e.g., summing) the tone scores of the individual clauses.

Each of the multiple candidate digital components are ranked (312). In some implementations, the multiple candidate digital components can be ranked based on results of the post-processing operations. The candidate digital components can be ranked based on any of the scores/evaluations discussed above, or a combination of the scores/evaluations discussed above. For example, the post-processing apparatus can sum or average multiple different scores to obtain an aggregate score for a clause, set of clauses, or candidate digital component. In some implementations, the scores can be weighted based on a relative importance of each evaluation to obtain the aggregate score (e.g., weighted average), which can be determined by a system administrator, system architect, and/or machine learning models that evaluate performance feedback of candidate digital components. Using the aggregate scores, the clauses, sets of clauses, or candidate digital components, can be ranked (e.g., from highest score to lowest score).

At least one output digital component is served based on the rankings (314). The at least one output digital component can be selected, for example, from among the highest-ranking candidate digital components, which can be classified as output digital components. More specifically, if one output digital component is to be served, the highest ranked output digital component can be served. If more than one output digital component is going to be served, a set of multiple output digital components that are within the set of highest-ranking digital components can be served. Serving the output digital component can include transmitting instructions that cause presentation of the output digital component at a client device.

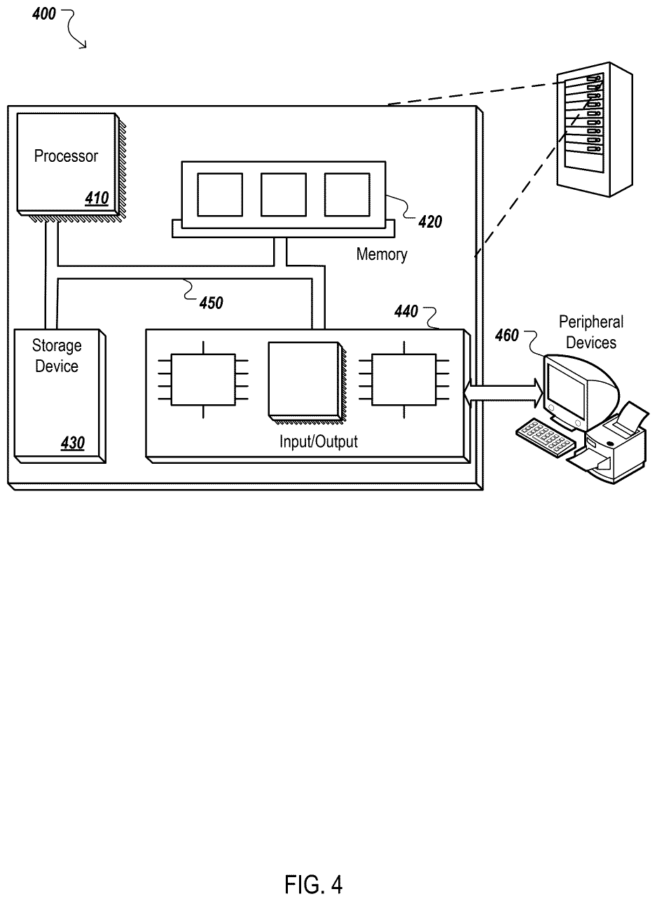

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
generating, by an artificial intelligence system, a prompt that includes a query and a set of constraints that limit clauses generated by a language model, wherein the set of constraints includes a summary of a specified source of online content;
generating, by the artificial intelligence system, multiple candidate digital components using clauses generated by the language model using the summary of the specified source of online content;
performing, by the artificial intelligence system, one or more post-processing operations that evaluate one or more characteristics of the multiple candidate digital components;
ranking, by the artificial intelligence system, each of the multiple candidate digital components based on the post-processing operations; and
serving, by the artificial intelligence system, at least one output digital component that is in a set of highest ranked candidate digital components.

2. The method of claim 1, further comprising:
collecting passages from a set of online resources using a site-constrained query that requires the passages be collected from one or more network locations specified in a site-constraint; and
summarizing the passages collected from the one or more network locations into a passage summary.

3. The method of claim 2, wherein generating the prompt comprises inserting at least a portion of the passage summary into the prompt as a contextual constraint that limits content created by the language model to subject matter specified in the contextual constraint.

4. The method of claim 3, wherein generating the prompt comprises inserting an entity name of an entity referenced by the one or more network locations into the prompt as an entity constraint specifying that content identifying the entity must be included in content created by the language model.

5. The method of claim 4, wherein generating the prompt comprises inserting, into the prompt, a grounding constraint that requires content created by the language model to be present in a specified set of online resources.

6. The method of claim 5, wherein inserting a grounding constraint into the prompt comprises inserting a second level domain into the prompt that requires content created by the language model to be present in resources within the second level domain.

7. The method of claim 6, wherein generating the multiple candidate digital components comprises combining an output of the language model with a link to the second level domain.

8. The method of claim 1, wherein performing one or more post-processing operations that evaluate one or more characteristics of the multiple candidate digital components comprises:
generating, for each clause of an output of the language model, a grounding score specifying a likelihood that the clause is factual;
filtering the output of the language model by removing one or more clauses having a grounding score that fails to meet a grounding threshold that delineates between clauses that are classified as factual and not factual; and
replacing the one or more removed clauses with another clause of the output having a grounding score that meets the grounding threshold.

9. The method of claim 1, wherein performing one or more post-processing operations that evaluate one or more characteristics of the multiple candidate digital components comprises:
for each given candidate digital component among the multiple candidate digital components:
evaluating a relevance of the clauses in the given candidate digital component to the query of the prompt;
evaluating a level of completeness of the clauses specifying how comprehensively the clauses in the given candidate digital component describe topics in a second level domain that is linked to by the given candidate digital component; and
evaluating a tone of the clauses of the candidate digital component to determine whether the clauses characterize an item as positive or negative.

10. One or more non-transitory computer readable medium storing instructions, that when executed by an artificial intelligence system, causes the artificial intelligence system to perform operations comprising:
generating a prompt that includes a query and a set of constraints that limit clauses generated by a language model, wherein the set of constraints includes a summary of a specified source of online content;
generating multiple candidate digital components using clauses generated by the language model using the summary of the specified source of online content;
performing one or more post-processing operations that evaluate one or more characteristics of the multiple candidate digital components;
ranking each of the multiple candidate digital components based on the post-processing operations; and
serving at least one output digital component that is in a set of highest ranked candidate digital components.

11. The one or more non-transitory computer readable medium of claim 10, wherein the instructions cause the artificial intelligence system to perform operations further comprising:
collecting passages from a set of online resources using a site-constrained query that requires the passages be collected from one or more network locations specified in a site-constraint; and
summarizing the passages collected from the one or more network locations into a passage summary.

12. The one or more non-transitory computer readable medium of claim 11, wherein generating the prompt comprises inserting at least a portion of the passage summary into the prompt as a contextual constraint that limits content created by the language model to subject matter specified in the contextual constraint.

13. The one or more non-transitory computer readable medium of claim 12, wherein generating the prompt comprises inserting an entity name of an entity referenced by the one or more network locations into the prompt as an entity constraint specifying that content identifying the entity must be included in content created by the language model.

14. The one or more non-transitory computer readable medium of claim 13, wherein generating the prompt comprises inserting, into the prompt, a grounding constraint that requires content created by the language model to be present in a specified set of online resources.

15. The one or more non-transitory computer readable medium of claim 14, wherein inserting a grounding constraint into the prompt comprises inserting a second level domain into the prompt that requires content created by the language model to be present in resources within the second level domain.

16. The one or more non-transitory computer readable medium of claim 15, wherein generating the multiple candidate digital components comprises combining an output of the language model with a link to the second level domain.

17. The one or more non-transitory computer readable medium of claim 10, wherein performing one or more post-processing operations that evaluate one or more characteristics of the multiple candidate digital components comprises:
generating, for each clause of an output of the language model, a grounding score specifying a likelihood that the clause is factual;
filtering the output of the language model by removing one or more clauses having a grounding score that fails to meet a grounding threshold that delineates between clauses that are classified as factual and not factual; and
replacing the one or more removed clauses with another clause of the output having a grounding score that meets the grounding threshold.

18. The one or more non-transitory computer readable medium of claim 10, wherein performing one or more post-processing operations that evaluate one or more characteristics of the multiple candidate digital components comprises:
for each given candidate digital component among the multiple candidate digital components:
evaluating a relevance of the clauses in the given candidate digital component to the query of the prompt;
evaluating a level of completeness of the clauses specifying how comprehensively the clauses in the given candidate digital component describe topics in a second level domain that is linked to by the given candidate digital component; and
evaluating a tone of the clauses of the candidate digital component to determine whether the clauses characterize an item as positive or negative.

19. An artificial intelligence system comprising:
one or more memory devices; and
one or more computing devices configured to execute code including a set of instructions, wherein execution of the set of instructions causes the one or more computing devices to perform operations comprising:
generating a prompt that includes a query and a set of constraints that limit clauses generated by a language model, wherein the set of constraints includes a summary of a specified source of online content;
generating multiple candidate digital components using clauses generated by the language model using the summary of the specified source of online content;
performing one or more post-processing operations that evaluate one or more characteristics of the multiple candidate digital components;
ranking each of the multiple candidate digital components based on the post-processing operations; and
serving at least one output digital component that is in a set of highest ranked candidate digital components.

20. The system of claim 19, wherein the instructions cause the one or more computing devices to perform operations further comprising:
collecting passages from a set of online resources using a site-constrained query that requires the passages be collected from one or more network locations specified in a site-constraint; and
summarizing the passages collected from the one or more network locations into a passage summary.

21-27. (canceled)
